(19) United States
(12) Patent Application Publication
(10) Pub. No.: US 2010/0021083 A1
(43) Pub. Date: Jan. 28, 2010

(54) STATIC IMAGE PRESENTATION METHOD

(75) Inventors: Tsuei-Chi Yeh, Hsinchu County (TW); Wen-Ting Chiang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/235,618

(22) Filed: Sep. 23, 2008

(30) Foreign Application Priority Data
Jul. 24, 2008 (TW) 97128122

(51) Int. Cl. G06K 9/32

(52) U.S. Cl. 382/298; 382/296; 715/800

(57) ABSTRACT

A static image presentation method is disclosed. The static image mentioned above has as least one human face pattern. The static image presentation method includes: firstly, identifying the human face pattern on the static image to obtain a human face pattern center and a human face pattern range; and then, presenting the static image by zooming in the static image according to the human face pattern center and the human face pattern range.

### CROSS-REFERENCE TO RELATED APPLICATION

This application claims the priority benefit of Taiwan application serial no. 97128122, filed on Jul. 24, 2008. The entirety of the above-mentioned patent application is hereby incorporated by reference herein and made a part of specification.

### BACKGROUND OF THE INVENTION

1. Field of the Invention

The present invention generally relates to a static image presentation method.

2. Description of Related Art

Static image or still pictures can be generated by devices such as digital camera, digital video (DV), or camera cell phone, etc. To present such still images to consumers, devices such as PC, notebook, digital photo frame, and many other playback devices, are used for the purpose. The image presentation mechanism can be user controlled, or through auto-run “slide show”, to show on the device screen.

The conventional slide show function has the effect of zooming in the picture first at showing, and then zooming out the picture gradually. However, when zooming in the picture, the conventional slide show function merely rooms in at the centre region of the picture. Therefore, the roomed in part could be not the interested part. Taking a human object picture as an example, if the face of the human object is not at the centre of the picture, the roomed in part will be an inessential part of the image. Such zooming effect defies the original purpose to show users more relevant image information at the slide-show.

### SUMMARY OF THE INVENTION

Accordingly, the present invention is directed to provide a static image presentation method for avoiding zooming in at less interested part of the static image.

The present invention provides a static image presentation method. The static image has at least one human face pattern. The static image presentation method includes: firstly, identifying the human face pattern on the static image to obtain a human face pattern center and a human face pattern range; and then, presenting the static image by zooming in the static image according to the human face pattern center and the human face pattern range.

The present invention detects the human face pattern of the static image to be shown and rooms in the human face pattern according to the detected human face pattern center and range, and will not room in at inessential regions of the static image, thus making the show of the static image more humanized.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of processes of a static image presentation method according to an embodiment of the present invention.

FIG. 2A is a schematic view of a static image.

FIG. 2B is a schematic view of a part of a static image 200 presented by zooming in the static image.

FIG. 3A is a schematic view of another static image.

FIG. 3B is a schematic view of a part of a static image 300 presented by zooming in the static image.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Hereinafter the static image presentation method of the present invention is illustrated by a plurality of embodiment with reference to the following drawings, so as to make persons with ordinary skill in the art to understand the present invention more clearly and implement the present invention accordingly.

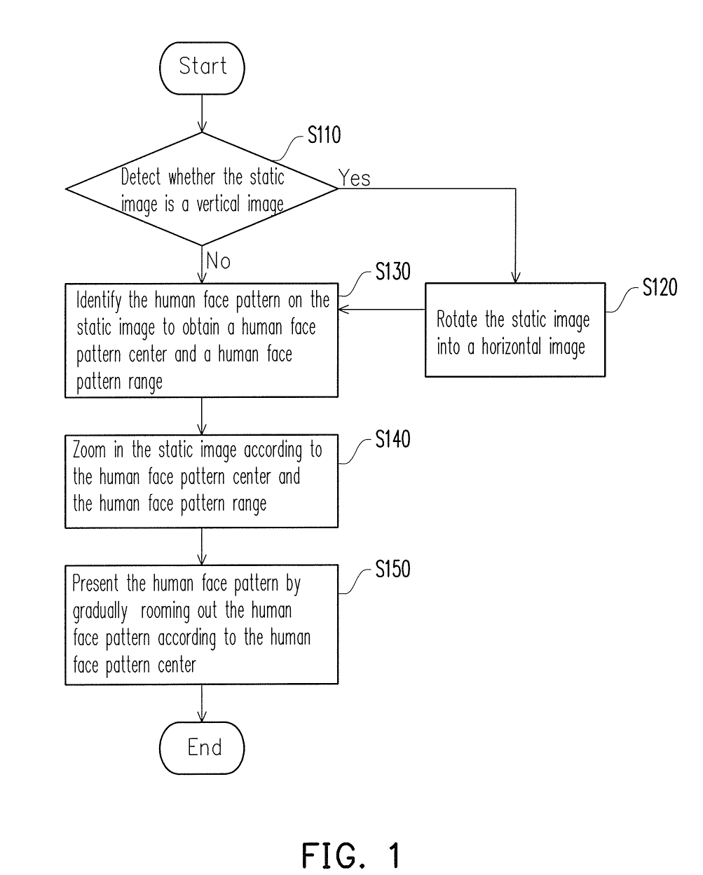

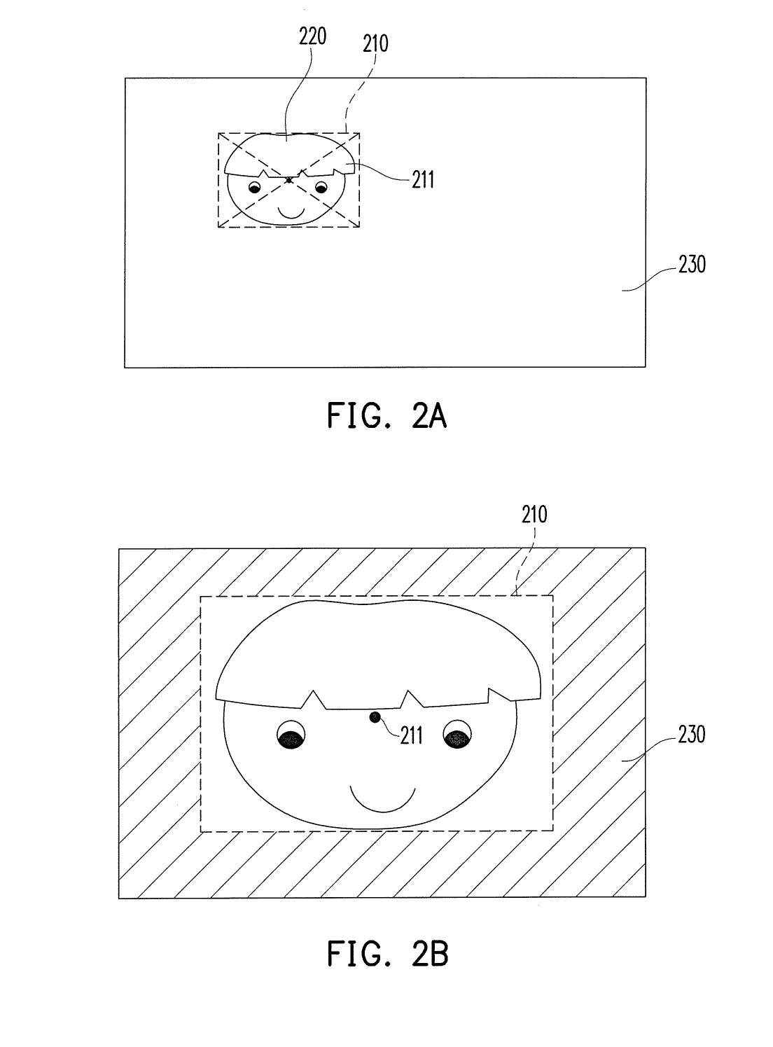

First, referring to FIG. 1, a flow chart of processes of a static image presentation method according to an embodiment of the present invention is shown. The steps of the embodiment are illustrated as follows. First, detect if there is any human face object on the image. If not, zoom in to the center of this image for slide show. If there is human face object found, then determine if the orientation of the image to be vertical like FIG. 2C image 400, or horizontal image like FIG. 2A image 200. First, whether the static image to be shown is a vertical image is detected (Step S110). Example of a vertical image is shown in FIG. 2C image 400 and 500. If the detected static image is a vertical image, the static image is rotated to be a horizontal image (Step S120) and FIG. 2D image 600.

It should be noted that several relative methods mentioned above are provided to illustrate the technique for detecting whether the static image is a vertical image for describing the present invention, but this embodiment is not limited to the mentioned detection methods.

Further, when rotating the static image detected to be a vertical image, the static image is rotated by 90 degrees or 270 degrees, so as to prevent the human object on the static image from being inverted.

Next, according to this embodiment, the human face pattern center and a human face pattern range are determined according to the human face pattern that is identified on the static image (Step S130).

The human face pattern center refers to a geometric center of the human face pattern range, or a geometric center of the human face pattern or any point on the human face pattern. FIG. 2A is a schematic view of a static image. Referring to FIG. 2A together, a static image 200 has a human face pattern 220. A human face pattern range 210 is obtained after the human face identification. In this embodiment, the human face pattern range 210 is set to be rectangular, so the intersection point of two diagonals of the human face pattern range 210 is a human face pattern center 211.

Herein, the reason why the human face pattern range 210 is rectangular lies in that static images are generally shown on a rectangular display (for example, display screen of a notebook or digital photo frame). Therefore, the human face pattern range has a rectangular shape herein.

Next, referring to FIG. 1 again, after obtaining the human face pattern range 210 and the human face pattern center 211, the static image is roomed in according to the human face pattern range 210 and the human face pattern center 211 (Step S140). FIG. 2B is a schematic view of a part of the static image 200 presented by zooming in the static image. Referring to FIG. 2B, the action of zooming in the static image is performed on the human face pattern range 210 and a peripheral range 230 (the shaded region shown in FIG. 2B), with the human face pattern center 211 as a center point, to fill the presentation screen. Herein, the addition of the peripheral range 230 aims to get a more aesthetic effect when presenting the human face pattern by zooming in the human face pattern. The size of the peripheral range 230 can be adjusted by the designer or user.

Next, referring to FIG. 1, after presenting the human face pattern by zooming in, the human face pattern is presented by zooming out according to the human face pattern center (Step S150), till the whole static image is presented on the presentation screen.

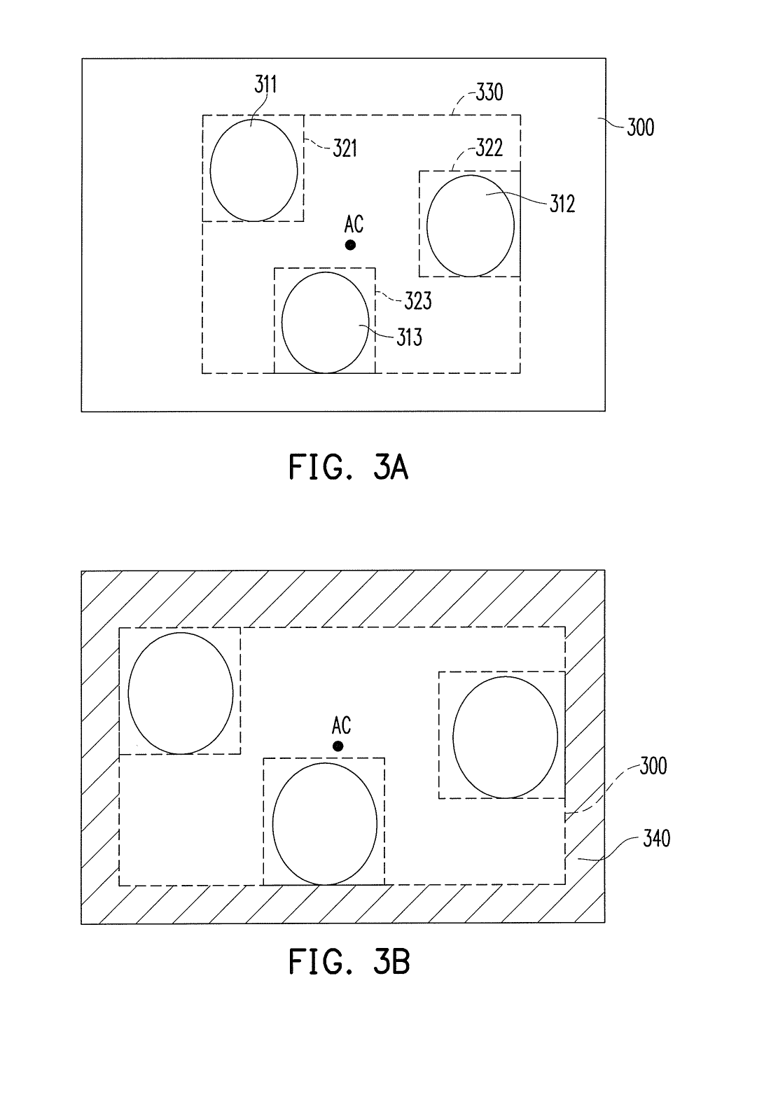

Further, if the static image has more than one human face pattern, the human face pattern center and the human face pattern range can be obtained according to the following manners. FIG. 3A is a schematic view of another static image. Referring to FIG. 3A, a static image 300 has three human face patterns 321-323. A human face pattern range 330 obtained by identifying the human faces of the static image 300 is a smallest local range surrounding the human face patterns 321-323. In this embodiment, the human face pattern range 330 is a rectangle, and the center of the rectangle is the intersection point of two diagonals of the human face pattern range 330, i.e., the human face pattern center AC.

Further, the human face pattern center AC can also be a geometric center or any point of any of the human face patterns 321-323. The case that the intersection point of two diagonals of the human face pattern range 330 serves as the human face pattern center AC is merely an example, but not to limit the present invention.

FIG. 3B is a schematic view of a part of the static image 300 presented by zooming in the static image. Referring to FIG. 3B, when zooming in the static image 300 with the plurality of the human face patterns, as the same as that when presenting the human face pattern of the static image 200 by zooming in the static image 200, the static image 300 is roomed in with the human face pattern center AC as a center according to the smallest local range 330 and a peripheral range 340.

The size of the peripheral range 340 can be adjusted by the designer or user. The set of the peripheral range 340 aims to make the static picture presented by zooming in the static image to be more aesthetic.

In view of the above, the present invention identifies the human face pattern on the static image, and presents the static image by zooming in the static image according to the human face pattern center and human face pattern range obtained by identification. Therefore, when showing the static image of a human object, the face of the human object can be presented by zooming in the static image accurately without presenting the invalid part of the static image.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A static image presentation method, wherein the static image has at least one human face pattern, comprising:
identifying the human face pattern on the static image to obtain a human face pattern center and a human face pattern range; and
presenting the static image by zooming in the static image according to the human face pattern center and the human face pattern range.

2. The static image presentation method according to claim 1, further comprising:
presenting the static image by zooming out the static image according to the human face pattern center.

3. The static image presentation method according to claim 1, further comprising:
detecting whether the static image is a vertical image; and
rotating the static image into a horizontal image when the static image is a vertical image.

4. The static image presentation method according to claim 3, the step of rotating the static image into a horizontal image comprises rotating the static image by 90 degrees or 270 degrees.

5. The static image presentation method according to claim 1, wherein the human face pattern center is a geometric center of the human face pattern range or any point in the human face pattern.

6. The static image presentation method according to claim 1, wherein the human face pattern range is a local range on the static image occupied by the human face pattern.

7. The static image presentation method according to claim 1, wherein then the static ima e has a plurality of human face patterns, the human face pattern range is a smallest local range surrounding all the human face patterns.

8. The static image presentation method according to claim 7, wherein the human face pattern center is a geometric center of the smallest local range, or a geometric center or any point of any of the human face patterns.

9. The static image presentation method according to claim 1, wherein the step of presenting the static image by zooming in comprising:
zooming in the human face pattern range and a peripheral range with the human face pattern center as a center point.
